(19) United States
(12) Patent Application Publication
(10) Pub. No.: US 2022/0402090 A1
(43) Pub. Date: Dec. 22, 2022

(54) Method for operating a machine tool, and machine tool

(71) Applicant: Hilti Aktiengesellschaft, Schaan (LI)

(72) Inventors: Stoyanka IVANOVA, Landberg am Lech (DE); Axel FISCHER, Wiedergeltingen (DE); Christian KOSCHEL, Augsburg (DE); Jan FRIEDMANN, Denklingen (DE); Franz MANDL, Feldkirch (AT); Can ICÖZ, Muenchen (DE); Dan TALPEANU, Stuttgart (DE); Florian SCHMID, Buchs SG (CH)

(21) Appl. No.: 17/774,224

(22) PCT Filed: Nov. 13, 2020
(86) PCT No.: PCT/EP2020/082081

§ 371 Date: May 4, 2022

(30) Foreign Application Priority Data
Nov. 21, 2019 (EP) 19210594.8

(51) Int. Cl. B24B 23/02; B24B 49/00

(52) U.S. Cl. CPC B24B 23/028; B24B 49/00

(57) ABSTRACT

A method for operating a machine tool (1), in particular an angle grinder, comprising a tool (3) that can be rotatably brought into operative connection with a driven shaft (7), the machine tool (1) having a drive device (4) for actuating the driven shaft (7), a control device (8) for actuating the drive device (4) and at least one sensor device (9, 10) operatively connected to the control device (8). The sensor device (9, 10) is used to determine whether a device (3, 11) is operatively connected in a defined manner to a defined region of the machine tool (1), the control device (8) enabling operation of the drive device (4) only if the query result is positive. A machine tool (1) for carrying out a method of this kind is also described.

The invention relates to a method for operating a machine tool, in particular an angle grinder, comprising a tool, for example a cutting, grinding or diamond disk, that can be rotatably brought into operative connection with a driven shaft, and to a machine tool for carrying out a method of this kind.

### SUMMARY OF THE INVENTION

When using machine tools, for example angle grinders, sawing machines or the like, there is the risk that the machine tool will also be operated without a tool being provided and in particular without a protective device being provided. As a result, it is possible for operation of the machine tool to lead to injury to the user.

It is an object of the present invention to provide a method for operating a machine tool, by means of which method the risk of injury to a user when operating the machine tool is reduced. In addition, the object of the present invention is that of providing a machine tool for carrying out a method of this kind.

The present invention provides a method for operating a machine tool, in particular an angle grinder, comprising a tool that can be brought into operative connection with a driven shaft, the machine tool having a drive device for actuating the driven shaft, a control device for actuating the drive device and at least one sensor device operatively connected to the control device. According to the invention, the sensor device is used to determine whether a device is operatively connected in a defined manner to a defined region of the machine tool, and the control device enables operation of the drive device, in particular when requested by the user, only if the query result is positive.

By means of an embodiment according to the invention of a method for operating a machine tool, it can be determined in a simple manner whether the device is operatively connected to the defined region of the machine tool to the desired extent. Injury to a user by operation of the machine tool without the connection of the device or with a faulty connection of the device can thus be easily identified and reliably avoided by preventing operation of the drive device when requested by the user. By means of a method according to the invention, it is thus easy to distinguish between a safe state with the device installed and an unsafe state with the device not installed or not installed correctly.

The method according to the invention can in principle be used in all machine tools which have a tool that can be connected to a driven shaft, and therefore said method can also be used for sawing machines such as circular saws, jigsaws, reciprocating saws or the like, drilling machines, chisel hammers or the like.

In an advantageous embodiment of a method according to the invention, the sensor device can be used to determine whether a tool is coupled in a defined manner to the driven shaft and/or the sensor device can be used to determine whether an add-on device, in particular a protective hood, a suction device or a handle device, is connected in a defined manner to the defined region of the machine tool. For example, by determining a missing protective device and operation of the machine tool being prevented as a result, injury to a user can easily be prevented. One or more sensor devices can be provided, each of which monitors the presence and/or desired positioning of a tool and/or of an add-on device. If a plurality of sensor devices is provided, operation of the machine tool may be enabled when requested by the user only if a plurality of, in particular all, sensor devices, detect the presence and/or desired positioning of the tool and/or of the particular add-on device.

In an advantageous embodiment of a method according to the invention, the sensor device is designed to determine a tool type of a tool coupled to the driven shaft and/or a type of the add-on device on the basis of information stored in the control device. It is particularly advantageous if the control device sets operating parameters of the drive device on the basis of the determined tool type and/or the determined type of the add-on device and, depending on the type, switches between different operating modes, for example. When the machine tool is designed as an angle grinder, for example, a first operating mode can be set by the control device when a tool designed as a grinding disk is identified, a second operating mode can be set by the control device when a tool designed as a cutting disk is identified, and a third operating mode can be set by the control device when a tool designed as a diamond disk is identified. The operating modes can differ, for example, with regard to the speeds used when the machine tool is in operation.

It is particularly advantageous if the control device enables operation of the drive device when requested by the user only if further parameters stored in the control device are met on the basis of the determined tool type. For example, when a tool designed as a grinding disk is determined, operation of the drive device may be enabled only if a protective hood is in a predefined position and, for example, a suction device is additionally brought into operative connection with the machine tool. The control device can give a user feedback in an optical, acoustic and/or haptic manner by means of an output device if a condition required for operating the drive device is not present and, for example, can also transmit information to the user as to what kind of operation of the machine tool is required.

The sensor device can determine the tool type and/or the type of the add-on device, preferably on the basis of an optical, magnetic and/or electrostatic operating principle or the like, the particular device being designed to interact with the sensor device. For example, the tool can have a defined identification or a defined pattern on a surface facing the sensor device. The sensor device can have a light source and a photodetector, the light emitted by the light source being directed toward the tool and, on the basis of the signals received by the photodetector, the presence and/or desired positioning and/or a type of the tool is determined by means of the control device.

The present invention also provides a machine tool, in particular an angle grinder, comprising a tool that can be brought into operative connection with a driven shaft, the machine tool having a drive device for actuating the driven shaft, a control device for actuating the drive device, at least one sensor device that interacts with the control device and a device, in particular the tool and/or an add-on device or safety device designed, for example, as a protective hood, handle device, suction device or the like, that can be brought into operative connection in a defined manner with a defined region of the machine tool, the machine tool being designed to carry out the method that is described in more detail above.

The advantages stated for the method according to the invention also apply, mutatis mutandis, to a machine tool designed according to the invention. With a machine tool designed according to the invention, it is therefore possible to simply and reliably prevent injury to a user in the event that at least one device is not brought into operative connection with the defined region of the machine tool or is not brought into operative connection therewith to the desired extent.

### BRIEF DESCRIPTION OF THE DRAWINGS

Further advantages can be found in the following description of the drawings. An embodiment of the present invention is shown in the drawings. The drawings, the description and the claims contain numerous features in combination. A person skilled in the art will expediently also consider the features individually and combine them to form meaningful further combinations.

In the drawings:

FIG. 1 is a greatly simplified side view of a hand-held machine tool designed as an angle grinder, a tool designed as a cutting disk being arranged on a driven shaft of the angle grinder; and

FIG. 2 is a flow chart of an embodiment of a method according to the invention.

### DETAILED DESCRIPTION

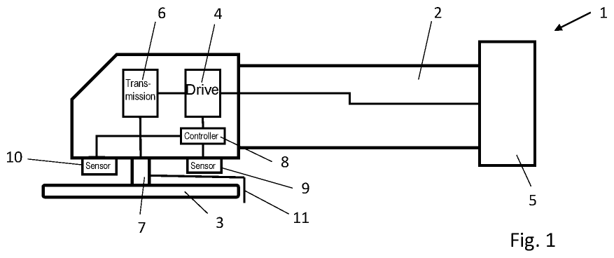

FIG. 1 shows a machine tool, in this case a hand-held machine tool 1 according to the invention, which is designed as an angle grinder in the illustration shown. According to an alternative embodiment, the machine tool 1 can also be designed as a drilling machine, as a sawing machine or the like.

The machine tool 1, which is designed as an angle grinder in the drawings, has a housing 2 and a tool 3, which is, for example, designed as a cutting disk. The housing 2 preferably has at least one holding region at which a user can hold and guide the machine tool 1 using one or both hands. Alternatively or additionally, a further handle device can be provided, which can preferably be detachably brought into operative connection with the housing 2 of the machine tool 1 and, for example, provides a different working position for the user.

The tool 3 can be actuated by a drive, which is in particular designed as an electric motor, or a drive device 4, which can be supplied with current in particular by means of an accumulator 5 that can be connected to the machine tool 1. According to an alternative embodiment, the machine tool 1 can also be supplied with electric current from a network by means of a power cable.

The drive 4 for actuating the tool 3, in this case in a rotating movement, is arranged in the interior of the housing 2 along with a transmission 6 and a driven shaft 7. The drive 4, which is designed, for example, as an electric motor, the transmission 6 and the driven shaft 7 are arranged in the housing 2 relative to one another and are interconnected in such a way that a torque generated by the electric motor 4 can be transmitted to the transmission 6 and finally to the driven shaft 7. A freely rotating end of the driven shaft 7 that projects downward from the housing 2 is connected to the tool, which is designed here as a cutting disk 3, for example via a clamping device (not shown in more detail). The torque of the driven shaft 7 can thus be transmitted to the cutting disk 3.

The machine tool 1 also has a control device 8 and, in the present case, two sensor devices 9 and 10. The sensor devices 9 and 10 are electrically and electronically connected to the control device 8. Signals can be sent between the sensor devices 9 and 10 and the control device 8. The control device 8 is in turn electrically and electronically connected to the electric motor 4 and the accumulator 5. Signals can be sent between the sensor devices 9 and 10 and the electric motor 4 and the accumulator 5. The control device 8 is used, inter alia, for controlling and regulating the drive 4 and for supplying power to the machine tool 1.

The first sensor device 9 is designed in the present case as an optical sensor device 9, it being possible use the first sensor device 9 to determine whether a protective device 11, for example a dust hood, is connected to the machine tool 1. In addition, the first sensor device 9 can preferably also be used to determine whether the protective device 11 is connected to the machine tool 1 to the desired extent, i.e. in particular whether it is correctly installed. This can be determined by evaluating the signals determined by the first sensor device 9 and, for example, by comparing these signals with parameters stored in the control device 8.

The control device 8 may enable operation of the machine tool 1 and thus actuation of the drive 4 only if the control device 8 determines the presence and, if necessary, correct installation of the protective device 11.

The first sensor device 9 is preferably also designed to determine a position of the protective device 11 if the protective device 11 can be connected to the housing 2 in different positions, for example when using different types of tools, such as a cutting disk or a grinding disk.

Alternatively or additionally, a sensor device can be provided by means of which the presence and, if necessary, correct installation of a handle device can be determined, which handle device can be brought into operative connection with the housing 2 of the machine tool 1. Similarly to the above statements, the control device 8 may enable operation of the machine tool 1 only if defined conditions are present.

A second sensor device 10, which in the present case is also designed as an optical sensor device, can also be seen in FIG. 1. The second sensor device 10 can be used to determine the presence and in particular the correct installation of the tool 3 in a manner analogous to the above statements regarding the first sensor device 9. Operation of the machine tool 1 can again be enabled only if the presence of a tool 3 and, in particular, additionally installation of a tool 3 to the desired extent is determined.

In the present case, the second sensor device 10 is additionally designed to determine the kind of the tool 3, it being possible for the second sensor device 10, in combination with the control device 8, to be used to determine the kind or type of the tool 3 used, for example by interacting with an in particular specific surface of the particular tool 3, which surface varies for example in the circumferential direction of the tool 3 and differs in a defined manner for different tool types.

In the control device 8, for example, different conditions or parameters can be stored for each kind or each type of tool 3, which parameters must be met in order to enable operation of the machine tool 1.

Alternatively or additionally, different operating modes for controlling the drive 4 are stored in the control device 8, a defined operating mode being set depending on the determined tool type. For example, a set speed of the driven shaft 7 can differ depending on the determined tool type such that the machine tool 1 is operated, for example, at a different speed when the grinding disk is determined than when the cutting disk is determined.

As an alternative to the embodiment of the sensor devices 9, 10 in the form of optical sensor devices, the first sensor device 9 and the second sensor device 10 can work according to a magnetic, electrostatic or other physical operating principle.

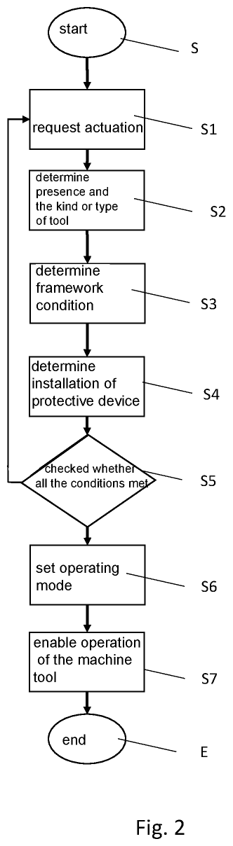

FIG. 2 shows, in a simplified manner, the sequence of an embodiment of a method according to the invention, by means of which method safe operation of the machine tool 1 can be ensured in a simple and reliable manner.

The method begins at the start S. In a first step S1, the user requests actuation of the drive 4, for example by actuating a switch (not shown in more detail). In step S2, the presence and the kind or type of the tool is determined by the second sensor device 10. In step S3, the framework conditions required for the determined tool type are determined in the control device 8. For example, the presence of the protective device 11 in a defined position may be required for the currently determined tool type.

In step S4, the first sensor device 9 is used to determine whether the protective device 11 is present and whether said protective device is installed in the desired position. In the following step, step S5, it is checked whether all the conditions required for the determined tool type are met. If this is not the case, the method is continued here with step S1. If, in contrast, all the stored conditions are met, the method is continued with step S6, an operating mode stored in the control device 8 for the determined tool type being set in this step in the present case.

In the following step, step S7, the operation of the machine tool 1 is enabled in the present case so that the user can work safely with the machine tool 1 to the desired extent. In step E, the method is ended in particular when the electric motor 3 is no longer operated by the user.

1-8. (canceled)

9: A method for operating a machine tool having a tool rotatably bringable into operative connection with a driven shaft, the machine tool having a drive for actuating the driven shaft, a controller for actuating the drive device and at least one sensor operatively connected to the controller, the method comprising:
determining, using the sensor, whether a device is operatively connected in a defined manner to a defined region of the machine tool, the controller enabling operation of the drive only if the determining result is positive.

10: The method as recited in claim 9 wherein the sensor is used to determine whether the tool is coupled to the driven shaft.

11: The method as recited in claim 9 wherein the sensor is used to determine whether an add-on device is connected in the defined manner to the defined region of the machine tool.

12: The method as recited in claim 11 wherein the add-on device is a protective hood.

13: The method as recited in claim 11 wherein the add-on device is a handle.

14: The method as recited in claim 11 wherein the sensor is designed to determine a type of the add-on device on the basis of information stored in the control device.

15: The method as recited in claim 9 wherein the sensor is designed to determine a tool type of the tool coupled to the driven shaft.

16: The method as recited in claim 15 wherein the controller sets operating parameters of the drive on the basis of the determined tool type.

17: The method as recited in claim 15 wherein the controller enables operation of the drive only if further parameters stored in the controller are met on the basis of the determined tool type.

18: The method as recited in claim 9 wherein the sensor is an optical, electrostatic or magnetic sensor.

19: The method as recited in claim 9 wherein the machine tool is an angle grinder.

20: A machine tool for carrying out the method as recited in claim 9, the machine tool comprising the tool, the drive, the controller, and the at least one sensor.

21: The machine tool as recited in claim 20 wherein the machine tool is an angle grinder.
